(19) United States
(12) Patent Application Publication
(10) Pub. No.: US 2023/0097625 A1
(43) Pub. Date: Mar. 30, 2023

(54) Type of a Box for Natural Sagging of Fish Bait Hook

(71) Applicant: Yalin Chen, Shandong (CN)

(72) Inventor: Yalin Chen, Shandong (CN)

(21) Appl. No.: 17/507,753

(22) Filed: Oct. 21, 2021

(30) Foreign Application Priority Data
Sep. 29, 2021 (CN) 202111153886.X

(51) Int. Cl. A01K 97/06; B65D 25/10

(52) U.S. Cl. CPC A01K 97/06; B65D 25/10

(57) ABSTRACT

This invention discloses a box for natural sagging of fish bait hook, including box placing tube. According to the size of each bait, the size of the hook and the number of hooks, the exclusive size of the different bait and the placing tube corresponding to the position of the hook are made. The placing tube makes grooves according to different bait shapes to jam the fish body. The fish hook hangs naturally in the placing tube. A hinge base is fixed between the cover body and the box body. There is a compression stripe on the cover body, which just presses the fish body when it is closed, so that it cannot move. It is to solve the functional problem of the fishing hooks which have no the function to prevent the hooks from entanglement and difficult separation.

### BACKGROUND OF THE INVENTION

This invention involves with the technical field of fishing tackle, especially with a box for natural sagging of fish bait hook.

With the spring up of lure such as fishing, fishing enthusiasts frequently appear by the sides of the river and pond sides. Different from the traditional fishing methods, the fish bait used by the lure fishing is the emulated fish bait. The fish bait is fixed with one or two hooks, anglers ceaselessly make pole-throwing and traction to simulate small-fish’s movement and induce large-size carnivorous fishes to bite the hooks. Generally, the lure fish bait is contained in a small box. Since the fish bait is accompanied with hooks, they are liable to entanglement, and at use, they shall be individually separated. At the separation, by accident the hook will damage the hands, and the fish baits of different length are impossible to be accurately placed. And more, if the fish baits are not timely wiped and placed in the box after use, the hook body will be corroded by the grown-bacterium. In addition, at filed fishing, the box is placed on the ground, fishing point is by the water side or slope, the box will be carelessly kicked out or drop onto the lower water body. Due to lack of the box fixation unit, this scheme correspondingly solves the above-mentioned problems. The inside of the box is additionally set with the deep groove for placing the hooks, so as to make the hooks suspend in the deep-groove and prevent the hooks from mutual entanglement. At the same time, the inside of the box body is additionally placed with the water absorbing cotton to absorb the water drop from the fish bait and prevent the hooks from corrosion by the collected water. It improves the box bottom and additionally fixes with a containable fixation pin which fixes the box and prevents the box from dropping at the filed fishing.

### BRIEF SUMMARY OF THE INVENTION

This invention aims to provide a type of a box for natural sagging of fish bait hook to solve functional problems to prevent hooks from entanglement and difficult separation indicated in the above-mentioned background technology.

In order to realize the objective, this invention provides the following technical scheme: A type of a box for natural sagging of fish bait hook, including box body. It is characterized that the top and the bottom at one side of the said box body are separately set with fixation grooves. One side of the said box body is set with a cover body and a hinge base is fixed between cover body and box body. The cover body realizes its rotation through the hinge fixation fitted between the hinge base and the box body. Relative to the right side of box body, the cover body is laterally and symmetrically set with 2 groups of fixation buckles matched with fixation groove. The inside of box body is placed with the porous drain plate, the front of porous drain plate is vertically arranged with 5 groups of placing tubes: first placing tube, second placing tube, third placing tube and fourth placing tube, and a water absorbing structure is fixed between the box body and the porous drain plate.

Preferentially, the said water absorbing structure includes a reserved groove, both sides of the bottom of the said reserved groove are provided with the clamp groove and the inside of the said reserved groove is inserted with the hollow net plate, the bottom end of the hollow net plate is fixed with a cover plate and both sides of the top of the said cover plate are separately fixed with the clamp feet matched with the clamp groove.

Preferentially, the said first placing tube, second placing tube, third placing tube and fourth placing tube on the same line shall be identical in height, and the said first placing tube, second placing tube and third placing tube on the same line shall have equal interval and both sides of the said both first placing tube and second placing tube shall be set with notches of the same dimensions. The left side of the said third placing tube is set with a notch.

Preferentially, the front of the said cover body is vertically fixed with two columns of second compression stripe and first compression stripe, 5 groups of the second compression stripe and the first compression stripe are separately set, and the thickness of second compression stripe is larger than that of the first compression stripe.

Preferentially, the inside of the said hollow net plate is placed with the water-absorbing cotton and the top of the said hollow net plate is set with an insertion port whose size is bigger than that of the water-absorbing cotton.

Preferentially, the rear end of the said box body is provided with a pin insertion groove and the inside of the pin insertion groove is fixed with a magnetic plate and the bottom of the rear end of the said box body is set with a semi-circle groove, the inside of semi-circle groove penetrates the inside of pin insertion groove. The inside of pin insertion groove is placed with metallic insertion pins.

Preferentially, the median of the top of the said box body is fixed and connected with a fixing pin groove and the inner width of the said fixing pin groove is matched with the outside size of the metallic insertion pins.

Preferentially, the bottom of the said cover plate is opened with an insertion type groove and the bottom of the said cover plate flushes with the bottom of the box body.

Preferentially, the front of the said porous drain plate is vertically arranged with 4 columns of placing-grooves and each column is set with 5 groups of the said placing-grooves. Both the top and the bottom of each said placing-groove are fixed with separation plates and each has the equal inner dimensions.

Preferentially, the first front 3 columns of placing-groove have the equal interval and the centers of placing-groove of the same column are at a same horizontal line.

Compared with the prior art, the beneficial effects of this invention are that the box for natural sagging of fish bait hook realizes the function to prevent the hooks from entanglement and difficult separation, to absorb the collected water, to prevent the hooks from corrosion, and to fix the box to avoid dropping.
(1) It sets with first placing tube, second placing tube, third placing tube and fourth placing tube. At use, a proper placing tube is selected as per the actual size of the fish bait. For placing small-sized fish baits, the fish baits are placed in first placing tube or second placing tube, their heads are left towards and tails are right towards, and the hooks are subsequently placed in the inner space of the first placing tube and the second placing tube; for placing rather large-sized fish baits, the fish baits placed in the first placing tube, the second placing tube or the third placing tube. Their heads are leftwards and their tails are rightwards, the hooks are placed in the inner space to make them naturally sag. When the cover body is closed, since the top of the fish bait adopts arc design at different height, the second compression stripe and the first compression stripe of different thickness will surely and accurately press the fish baits under the stripe, which will prevent several hooks from entanglement resulted from fish bait’s displacement due to turning over of the box body during the movement course, and realize the function to prevent hooks from entanglement and difficult separation.
(2) It sets with the reserved groove, the clamp groove, the hollow net plate and the cover plate. The user with his fingers holds the inside of the insertion type groove, pulls out the hollow net plate from the inside of the reserved groove, places the water-absorbing cotton from the insertion port into the inside of the hollow net plate, then pushes back the hollow net plate and fixes the hollow net plate with the clamp feet and clamp groove. During the use, when the angler finishes his fishing activity, the used fish bait is placed in the box body, the collected water of the fish baits will ceaselessly downwards leak from the holes designed in the porous drain plate, the leaked water is completely absorbed by the water-absorbing cotton under the fish bait groove, and prevents hook body from corrosion by the bacterium in the water collected in the box body bottom. The angler may regularly take out the water-absorbing cotton for air-dry and sterilization, and realizes the function of absorbing the collected water and preventing corrosion by the collected water.
(3) It sets with the pin insertion groove, magnetic plate, metallic insertion pin and semi-circle groove. During the field fishing, after fixing fish bait, the user may take the metallic insertion pin out from the pin insertion groove. The semi-circle groove will provide the user hand-operation space sufficient for his taking out the metallic insertion pin. Then, the user may place the box body on the ground, insert the metallic insertion pin into the empty groove inside the fixing pin groove and finish the fixation. For storage after fishing, the user will merely pull out the metallic insertion pin and insert it to the pin insertion groove again. The magnetic plate will absorb and hold the metallic insertion pin by the magnetic force, which will prevent the metallic insertion pin from dropping, and realize the function to fix the box and protect it from dropping.

### BRIEF DESCRIPTION OF THE DRAWINGS

FIG. 1 is the front-section schematic structural drawing of this invention;

FIG. 2 is the up wards schematic structural view of the box body of this invention;

FIG. 3 is the up wards schematic structural view of the reserved groove of this invention;

FIG. 4 is the front-section schematic structural view of hollow net plate of this invention;

FIG. 5 is the rear wards view of structure of the box body of this invention;

FIG. 6 is the schematic diagram of the installation mode of the placing-groove of this invention;

In the diagrams: 1. box body, 2. fixation groove, 3. porous drain plate, 4A. the first placing tube, 4B. the second placing tube, 5. the third placing tube, 6. the fourth placing tube, 7. cover body, 8. fixation buckle, 9. first compression stripe, 10. second compression stripe, 11. hinge base, 12. fixation pin groove, 13. reserved groove, 14. cover plate, 15. insertion type groove, 16. clamp groove, 17. clamp feet, 18. hollow net plate, 19. water-absorbing cotton, 20. insertion port, 21. pin insertion groove, 22. semi-circle groove, 23. metallic insertion pin, 24. magnetic plate, 25. separation plate, 26. placing-groove

### DETAILED DESCRIPTION OF THE INVENTION

In the following pages, the technical scheme of this invention indicated in the diagrams of the implement examples will be clearly and completely described in combination with the diagrams of this invention. Obviously, the described implementation examples are merely a part of the implementation examples of this invention, and they are not the entire implementation examples of this invention. All other implementation examples which the common technician in this field made on basis of implementation examples of this invention without offering any creative labor belong to the protection scope of this invention.

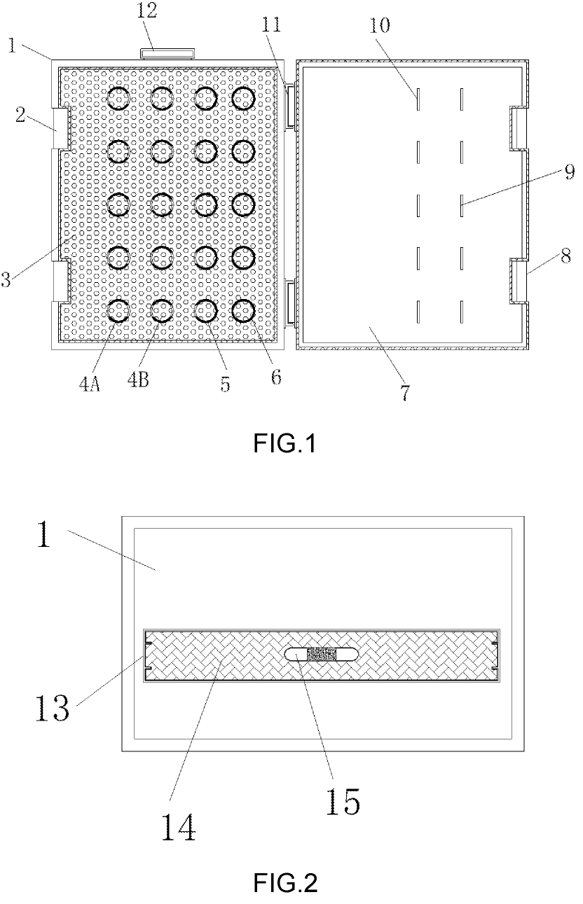

Implementation example 1: Refer to FIGS. 1-6, a type of a box for natural sagging of fish bait hook, including box body 1. Both the top and the bottom of one side of the said box body are separately set with fixation groove 2. Relative to the right side of box body 1, cover body 7 is laterally and symmetrically set with two groups of fixation buckles 8 matched with fixation groove 2. The inside of box body 1 is placed with porous drain plate 3, the front of porous drain plate 3 is vertically arranged with five groups of placing tubes, each of first placing tubes 4A, second placing tube 4B, third placing tube 5 and fourth placing tube 6.

In the same line, the first placing tube 4A, second placing tube 4B, third placing tube 5 and fourth placing tube 6 are identical in height, and in the same line the first placing tube 4A, second placing tube 4B, third placing tube 5 have equal interval, and both sides of the both first placing tube 4A and second placing tube 4B are set with notches of the same dimensions. The left side of the third placing tube 5 is set with a notch.

Especially, as shown in FIG. 1, at the use, a proper placing area is selected as per the actual size of the fish baits. For placing the small-sized fish baits, the fish baits are placed in first placing tube 4A or second placing tube 4B, their heads are left towards and tails are right towards, and the hooks on the fish bait are subsequently placed in the inner space of the first placing tube 4A and the second placing tube 4B; for placing rather large-sized fish baits, the fish baits are placed in the first placing tube 4A, second placing tube 4B and third placing tube 5. Their heads are leftwards and tails are rightwards, the hooks are placed in the inner space to make them naturally sag. It should be noted that it is not limited to set the first placing tube 4A, second placing tube 4B, third placing tube 5 and fourth placing tube 6 in 4 groups. For placing rather large fish bait, the quantity (i.e. quantity of the columns) of first placing tube 4A, second placing tube 4B, third placing tube 5 and fourth placing tube 6 may be properly added as per the actual conditions.

Implementation example 2: The front of porous drain plate 3 is vertically arranged with four columns of placing-groove 26, each column is placed with five groups of placing grooves. Both the top and the bottom of placing-groove 26 are fixed with separation plate 25, and the inner dimensions of the placing-groove 26 are same.

The first three columns of placing-groove 26 are at the same interval, and the centers of placing-grooves 26 on the same column are at a same horizontal line.

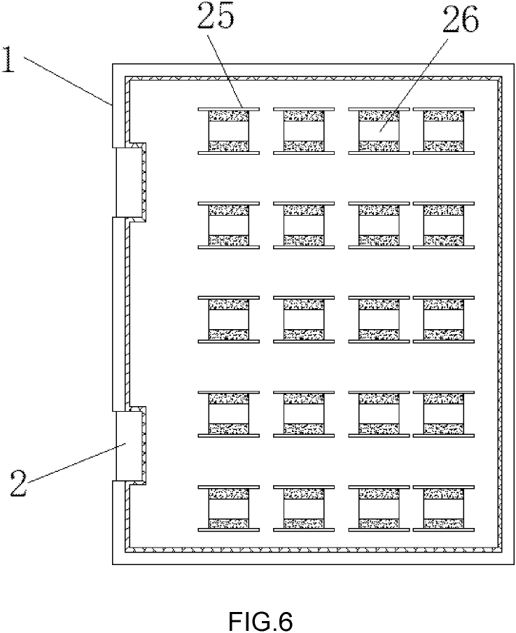

Especially, as shown in FIG. 6, the placing area of the fish bait may be designed to the second type. For placing small-size fish baits, the fish baits may be placed in the first two columns of placing-groove 26, their heads are left towards and tails are right towards, and the fish tails are fixed with the inner holding area of placing-groove 26. The hooks on the fish bait is placed into the inside space of placing-groove 26. For placing the rather big fish baits, the fish baits are placed in the three first columns of placing-groove 26, their heads are left towards and tails are right towards so as to make the hooks naturally sag. The placing areas are effectively divided by setting of separation plate 25. It should be noted that it is not limited to set placing-groove 26 in four groups. For placing rather large fish bait, the quantity of placing-groove 26 may be properly added as per the actual conditions.

Implementation example 3: The water absorbing structure is placed between box body 1 and porous drain plate 3. The water absorbing structure includes reserved groove 13, and the inside of reserved groove 13 is inserted with hollow net plate 18.

The inside of hollow net plate 18 is placed with water-absorbing cotton 19, and the top of hollow net plate 18 is opened with insertion port 20, whose size is bigger than that of water-absorbing cotton 19.

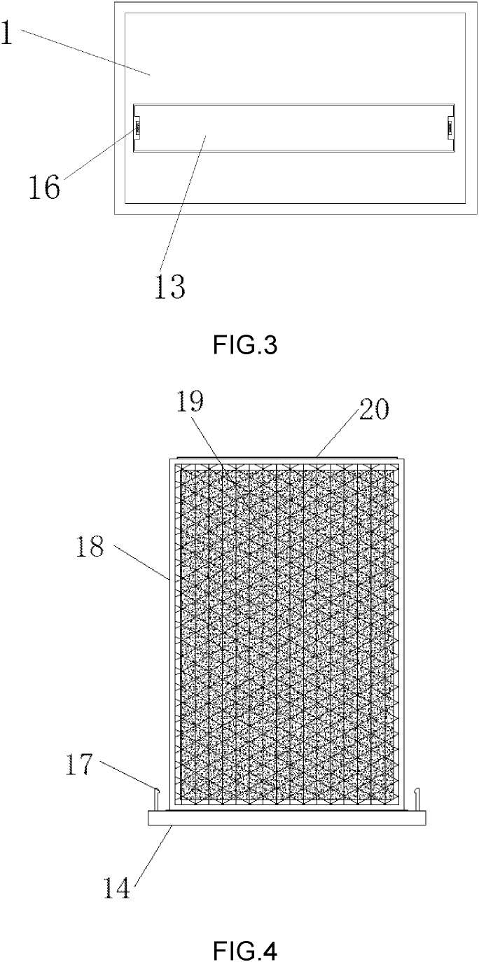

Especially, as shown in FIG. 2, FIG. 3 and FIG. 4, when the angler finishes his fishing activity, the used fish bait is placed in box body 1, the collected water of the fish bait will ceaselessly downwards leak through several holes designed on porous drain plate 3 and is completely absorbed by water-absorbing cotton 19 under fish bait groove. Water-absorbing cotton 19 is regularly taken out for air-dry and sterilization.

Implementation example 4: The both sides of the bottom of reserved groove 13 are set with clamp groove 16, the bottom of hollow net plate 18 is fixed with cover plate 14, and the both sides of cover plate 14 are fixed with clamp feet 17 matched clamp groove 16.

The bottom of cover plate 14 is set with insertion type groove 15, and the bottom of cover plate 14 flushes with the bottom of box body 1.

Especially, as shown in FIG. 2, FIG. 3 and FIG. 4, the user with his fingers holds the inside of insertion type groove 15, takes out hollow net plate 18 from the inside of reserved groove 13, place water-absorbing cotton 19 from insertion port 20 to the inside of hollow net plate 18, pushes back hollow net plate 18 again, and fix hollow net plate 18 with clamp feet 17 and clamp groove 16.

Implementation example 5: One side of box body 1 is set with cover body 7, and hinge base 11 is fixed between cover body 7 and box body 1. Cover body 7 realizes its turning over through the hinge fixation between hinge base 11 and box body 1. The front of cover body 7 is vertically fixed with two columns of second compression stripe 10 and first compression stripe 9, second compression stripe 10 and first compression stripe 9 are each set with five groups, and the thickness of the second compression stripe 10 is bigger than that of the first compression stripe 9.

Especially, as shown in FIG. 1 and FIG. 6, when cover body 7 is closed, the top of the fish bait is of the curved design at different height, the different-thick second compression stripe 10 and first compression stripe 9 on the box cover may accurately compress the fish baits under them to avoid the displacement of fish bait resulted from the turning over of box body 1 during the movement course. After cover body 7 is closed, second compression stripe 10 and first compression stripe 9 in a same line are in the same horizontal line of first placing tube 4A, second placing tube 4B, third placing tube 5 and fourth placing tube 6 of the same line for easy compression and fixation. When using the second placing mode, second compression stripe 10 and first compression stripe 9 on the same line are in the same horizontal line of placing-groove 26, and thereby the fish bait is fixed.

Implementation example 6: The rear end of box body 1 is set with pin insertion groove 21, and the inside of pin insertion groove 21 is fixed with magnetic plate 24. The bottom of the rear end of box body 1 is set with semi-circle groove 22, and the inside of semi-circle groove 22 penetrates the inside of pin insertion groove 21. The inside of pin insertion groove 21 is set with metallic insertion pin 23.

The median of the top of box body 1 is fixed with and connected with fixing pin groove 12, and the inner width of fixing pin groove 12 is matched with the outside size of metallic insertion pin 23.

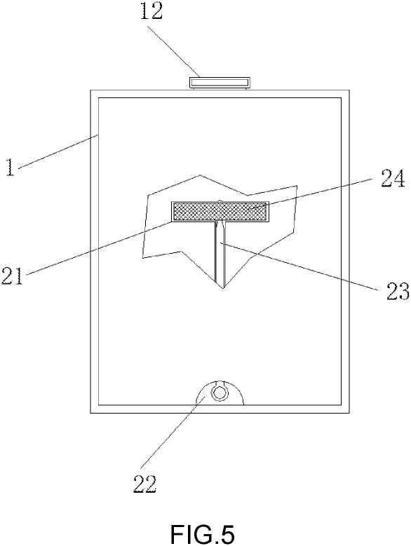

Especially, as shown in FIG. 1 and FIG. 5, during the field fishing, after fixing of the fish bait, the user takes out metallic insertion pin 23 from pin insertion groove 21 and semi-circle groove 22 provides the hand operation space sufficient for his taking out metallic insertion pin 23. Then, box body 1 is placed on the ground, metallic insertion pin 23 is inserted into the empty groove inside fixing pin groove 12 and the fixation is finished. For the storage of the fishing baits at finish of the fishing, one may insert metallic insertion pin 23 to pin insertion groove 21, and magnetic plate 24 may absorb and fix metallic insertion pin 23 by its magnetic force and prevent metallic insertion pin 23 from dropping.

Working principle: At use of this invention, at first, in the routine storage process, the user selects a proper placing area as per the actual size of the fish bait. In case of placing the small-size fish baits, the fish baits are placed in first placing tube 4A and second placing tube 4B and their heads are left towards and tails are right towards. The hooks on the fish bait are sequentially placed in the inner space of first placing tube 4A and second placing tube 4B. In case of placing rather big fish baits, the fish baits are placed in first placing tube 4A, second placing tube 4B and third placing tube 5, their heads are left towards and tails are right towards, the hooks are placed in the inner space so as to make them naturally sag. Meanwhile, another placing mode may be adopted. In case of placing the small-size fish baits, the fish baits are placed in the front two columns of placing-groove 26, and their heads are left towards and tails are right towards. The fish baits are fixed by the holding area inside placing-groove 26, and the hooks on the fish baits are placed in the space inside placing-groove 26. In case of placing rather big fish baits, the fish baits are placed in placing-groove 26 of the front three columns, their heads are left towards and tails are right towards to make the hooks naturally sag. When cover body 7 is closed, since the top of the fish bait is of the curved design at different height, the different-thick second compression stripe 10 and first compression stripe 9 may accurately press the fish baits under them to prevent displacement of fish bait resulted from turning over of the box body 1 during the movement course. After cover body 7 is closed, second compression stripe 10 and first compression stripe 9 of the same line are at the same horizontal line of first placing tube 4A, second placing tube 4B, third placing tube 5 and fourth placing tube 6 for easy compression and fixation. In case of the another placing mode, second compression stripe 10 and first compression stripe 9 of the same line are at the same horizontal line of placing-groove 26 and then the fish bait is fixed. Before the field fishing, after fixing the fish bait the user takes out metallic insertion pin 23 from pin insertion groove 21, and semi-circle groove 22 provides the user the hand operation space sufficient for his taking out metallic insertion pin 23. Then, box body 1 is placed on the ground, metallic insertion pin 23 is inserted into the empty groove inside fixing pin groove 12 and the fixation is finished. For storage at finish of the fishing, the user merely is required to withdraw metallic insertion pin 23 and insert it to pin insertion groove 21. Magnetic plate 24 may absorb and hold metallic insertion pin 23 by the magnetic force and prevent metallic insertion pin 23 from dropping. The inside of insertion type groove 15 is held by fingers, and hollow net plate 18 is pull out from inside of reserved groove 13. Water-absorbing cotton 19 is placed into hollow net plate 18 from insertion port 20. Then, hollow net plate 18 is pushed back, and is fixed by clamp feet 17 and clamp groove 16. The used fish baits are placed in box body 1, the collected water of the fish baits ceaselessly downwards leaks from several holes designed on porous drain plate 3 and is completely absorbed by water-absorbing cotton 19 under the fish bait groove. Water-absorbing cotton 19 is regularly taken out for air-dry and sterilization.

Obviously, for the technicians in this field, this invention is not limited to the details of above-mentioned demonstrative implementation example, and in case that the spirits of this invention or basic characteristics are not violated, they may realize this invention with other specific modes. Hence, viewed from any point, the implementation example shall be seemed to be demonstrative, instead of being restrictive. The scope of this invention is limited by the claims instead of by the above-mentioned description. The meanings of equivalent elements in the claims and the scope of all variations are included in this invention. Any reference mark in the claims shall not be deemed to limit the involved claims.

What is claimed is:

1. A type of a box for natural sagging of fish bait hook, including box body (1); It is characterized that both the top and the bottom of one side of box body (1) are separately set with fixation groove (2); One side of box body (1) is set with cover body (7) and hinge base (11) is fixed between cover body (7) and box body (1); The cover body (7) realizes its rotation through the hinge fixation fixed between the hinge base (11) and the box body (1); Relative to the right side of box body (1), cover body (7) is laterally and symmetrically set with 2 groups of fixation buckles (8) matched with fixation groove (2); The inside of box body (1) is fixed with porous drain plate (3), the front of porous drain plate (3) is vertically arranged with 5 groups of placing tubes: first placing tub (4A), second placing tube (4B), third placing tube (5) and fourth placing tube (6), and a water absorbing structure is fixed between box body (1) and porous drain plate (3).

2. A type of a box for natural sagging of fish bait hook in claim 1; It is characterized that the said water absorbing structure includes reserved groove (13), both sides of the bottom of reserved groove (13) is set with clamp groove (16), the inside of reserved groove (13) is inserted with hollow net plate (18), the bottom of hollow net plate (18) is fixed with cover plate (14), and both sides of the top of cover plate (14) are separately fixed with clamp feet (17) matched with clamp groove (16).

3. A type of the box for natural sagging of fish hook in claim 1; It is characterized the first placing tube (4A), second placing tube (4B), third placing tube (5) and fourth placing tube (6) on the same line are of the same height, and the first placing tube (4A), second placing tube (4B) and third placing tube (5) on a same line are equally separated; Both sides of the first placing tube (4A) and second placing tube (4B) are set with the notches of the same size, and the left side of third placing tube (5) is set with notch.

4. A type of a box for natural sagging of fish bait hook in claim 1; It is characterized that the front of cover body (7) is vertically fixed with two columns of second compression stripe (10) and first compression stripe (9), 5 groups of the second compression stripe (10) and the first compression stripe (9) are separately set, and the thickness of second compression stripe (10) is larger than that of the first compression stripe (9).

5. A type of a box for natural sagging of fish bait hook in claim 2; It is characterized that the inside of hollow net plate (18) is placed with water-absorbing cotton (19), and the top of hollow net plate (18) is set with insertion port (20) whose size is bigger than that of water-absorbing cotton (19).

6. A type of a box for natural sagging of fish bait hook in claim 1; It is characterized that the rear end of box body (1) is set with pin insertion groove (21), and the inside of pin insertion groove (21) is fixed with magnetic plate (24); The bottom of the rear end of box body (1) is set with semi-circle groove (22); The inside of semi-circle groove (22) penetrates the inside of pin insertion groove (21); The inside of pin insertion groove (21) is placed with metallic insertion pins (23).

7. A type of a box for natural sagging of fish bait hook in claim 1; It is characterized that the median of the top of box body (1) is fixed and connected with fixing pin groove (12) and the inner width of fixing pin groove (12) is matched with the outside dimensions of insertion pins (23).

8. A type of a box for natural sagging of fish bait hook in claim 2; It is characterized that the bottom of cover plate (14) is opened with insertion type groove (15), and the bottom of cover plate (14) flushes with the bottom of box body (1).

9. A type of a box for natural sagging of fish bait hook in claim 1; It is characterized that the front of porous drain plate (3) is vertically arranged with 4 columns of placing-groove (26), each placing-groove (26) is arranged with 5 groups; Both the top and bottom of placing-groove (26) are fixed with separation plate (25), and the inner dimensions of placing-groove (26) are same.

10. A type of a box for natural sagging of fish bait hook in claim 9; It is characterized that the front 3 columns of placing-groove (26) have the equal interval and the centers of placing-groove (26) are at a same horizontal line.
